(19) United States
(12) Patent Application Publication
(10) Pub. No.: US 2014/0277967 A1
(43) Pub. Date: Sep. 18, 2014

(54) DISTRIBUTED WORKSITE MANAGEMENT SYSTEM

(71) Applicant: Caterpillar Inc., Peoria, IL (US)

(72) Inventors: Christopher M. Sprock, Peoria, IL (US); Thomas F. Doherty, Holland Park (AU); Ryan Baumann, Peoria, IL (US); Daniel A. Daiber, Edwards, IL (US); Douglas R. Blaine, Bloomington, IL (US); Jonathon D. Ronna, Metamora, IL (US); Daniel J. Long, Washington, IL (US); Jingming Hou, Washington, IL (US)

(73) Assignee: Caterpillar Inc., Peoria, IL (US)

(21) Appl. No.: 14/287,466

(22) Filed: May 27, 2014

(51) Int. Cl. G06Q 10/06

(52) U.S. Cl. CPC G06Q 10/06311
USPC 701/50

(57) ABSTRACT

A distributed worksite data management system is provided. The system includes a plurality of machines, each having a data communication device and a controller on-board the machine. The controller is configured to read sensor data associated with the machine and transmit the sensor data to the data communication device. A worksite datacenter is accessible by the plurality of machines. The worksite datacenter is situated remotely from the worksite. The worksite datacenter includes a plurality of databases and application servers. An end user device is associated with the plurality of machines. The end user device is configured to visualize results of an execution of an application of the controller.

### TECHNICAL FIELD

The present disclosure relates to a distributed data management system, and more specifically to a system for managing data on a worksite.

### BACKGROUND

Machines operating on a worksite may have a centralized data management system associated therewith. The data management system may include various hardware devices for monitoring of machine data related to the machines operating on the given worksite.

The data management system may be implemented on the worksite of in a vicinity proximate to the worksite. These systems may require creation of a centralized data warehouse. Such systems may have growing hardware and software requirements based on needs of the system and on technological developments. As a result, these systems may be costly to deploy and support.

Hence there is a need for providing an improved data management system associated with machine oriented applications.

### SUMMARY OF THE DISCLOSURE

In one aspect of the present disclosure, a distributed worksite data management system is provided. The system includes a plurality of machines operating on a worksite. A data communication device is present on-board each of the plurality of machines. A controller is present on-board each of the plurality of machines. The controller is communicably coupled to the data communication device. The controller is configured to read sensor data associated with the machine and transmit the sensor data to the data communication device of the machine. A worksite datacenter is accessible by the plurality of machines. The worksite datacenter is situated remotely from the worksite. The worksite datacenter includes a plurality of databases and a plurality of application servers. The worksite datacenter is configured to communicate with the data communication device via a network, wherein the network is adapted to transmit data with a network protocol. The system includes an end user device associated with the plurality of machines. The end user device is configured to visualize results of the execution of the application.

Other features and aspects of this disclosure will be apparent from the following description and the accompanying drawings.

### BRIEF DESCRIPTION OF THE DRAWINGS

FIGS. 1 and 2 are block diagrams of an exemplary environment implementing a distributed worksite management system, according to one embodiment of the present disclosure.

### DETAILED DESCRIPTION

FIGS. 1 and 2 illustrate an exemplary environment implementing a distributed worksite data management system 100, according to one embodiment of the present disclosure. The system includes an exemplary worksite 104 or minesite.

A number of different machines 106-1, 106-2, . . . 106-n, hereinafter collectively referred as machines 106, configured for transportation of material from one location to another may be deployed on the worksite 104. The machines 106 may be for example, a mining truck, a haul truck, an on-highway truck, an off-highway truck, an articulated truck, and the like. Further, the machines 106 may also embody a number of different loading machines. The loading machine is configured to load the material onto other machines on the worksite 104. The type of loading machines may include, for example, a conveyor, a large wheel loader, a track-type loader, a shovel, a dragline, a crane or any other loading machine known to one skilled in the art. The machines 106 deployed on the worksite 104 may include manned machines, autonomous machines or semi-autonomous machines.

Referring to FIG. 2, a controller 108 is associated with the respective machines 106. The controller 108 is configured to monitor and/or read sensor data associated with the respective machines 106. The sensor data associated with the machines 106 may include, but not limited to, parameters related to operation of the machine 106, for example, machine speed, heading direction, location of the machine 106, on the worksite 104, or any other telematic sensory information associated with the machine 106.

The controller 108 may be present on-board each of the machines 106. In this embodiment, the controller 108 may be embodied as an electronic control module (ECM) of the respective machine 106. Alternatively, the controller 108 may be a separate control unit distinct from the ECM. In one embodiment, the controller 108 may be embodied as a remote control station; the remote control station being configured to receive the data from the ECM on-board each of the machines 106. In another embodiment, the controller 108 may be configured to control an operation of the machine 106 based on the monitoring of the sensor data.

The controller 108 is communicably coupled to a data communication device 109 associated with the machine 106. The data communication device 109 may be present on-board the machine 106. The data communication device 109 may include, but not limited to, a radio device, a cellular modem, a satellite modem, a Wi-Fi modem, and so on. The controller 108 is configured to transmit the sensor data associated with the machine 106 to the data communication device 109.

The data communication device 109 is communicably coupled to a worksite datacenter 110 via a network 112. The network 112 may be, but not limited to, a wide area network (WAN), a local area network (LAN), an Ethernet, an Internet, an Intranet, a cellular network, a satellite network, or any other suitable network for transmitting data between the data communication device 109 and the worksite datacenter 110. In various embodiments, the network 112 may include a combination of two or more of the aforementioned networks and/or other types of networks known in the art. The network 112 may be implemented as a wired network, a wireless network or a combination thereof. Further, data transmission make take place over the network 112 with a network protocol such that the data transmission is in an encrypted format, any other secure format, or in any of a wide variety of known manners.

In one embodiment, the data communication device 109 is adapted for converting data from a protocol of the controller 108 of the machine 106 into the network protocol. In this embodiment, the controller 108 on-board the machine 106 may send the sensor data of the machine 106 for example, encoded in the field bus protocol, to the data communication device 109. The data communication device 109 may then convert this sensor data into the network protocol for example, the Internet protocol, and further send the sensor data over the network 112 to the worksite datacenter 110.

The worksite datacenter 110 is deployed over a distributed environment, such as, but not limited to, a cloud facility, internet and virtual private network. The worksite datacenter 110 is a distributed data management system that is employed at a location or locations away from or remotely accessible to the machines 106 on the worksite 104. In one embodiment, the worksite datacenter 110 may be adapted to monitor and report the sensor data for the machines 106 operative in the single worksite 104. Alternatively, the worksite datacenter 110 may be configured to serve as a distributed data warehouse for the machines 106 operative in a given geographical space, such that multiple worksites 104 may be grouped under the same geographical space.

The worksite datacenter 110 may include a number of distinct application servers 113-1, 113-2, . . . 113-n, hereinafter collectively referred as application servers 113. Further, the worksite datacenter 110 may also include a number of databases 114-1, 114-2, . . . 114-n, hereinafter collectively referred to as databases 114. The databases 114 may include an Oracle database, a SQL database or any other database system known in the art. The application servers 113 may be adapted to execute an application of the controller 108, the application involving processing of the sensor data associated with the machine 106. The databases 114 may be communicably coupled to the application servers 113. The databases 114 are configured to store the sensor data and/or data required for the execution of the application related to the sensor data. The worksite datacenter 110 may offer virtualized resources as a service over the network 112 to the machines 106 deployed on the worksite 104.

The application servers 113 of the worksite datacenter 110 may host various functionalities thereon. The worksite datacenter 110 may further provide architecture for allowing distribution of functionalities across the various application servers 113 belonging to the same or different worksite datacenters 110, thereby hosting or leveraging services and capabilities that are dynamically scalable. The application servers 113 may be located at any location, which may even be remote from the other components of the worksite datacenter 110.

The application executed by the application server 113 is adapted to process the sensor data received over the network 112 and further may be adapted to generate control commands The worksite datacenter 110 may be adapted to send these control commands to the controller 108 associated with the machine 106, and thereby remotely control an operation thereof.

In one embodiment, the application server 113 is adapted to virtualize the execution of the application associated with the processing of the sensor data. Virtualization of an application involves hiding of the physical technical characteristics of the computing equipment and devices used by the worksite datacenter 110 to an operator of the machine 106 deployed on the worksite 104. The application servers 113 may simulate a single computer or a single processor on which the application is executed.

The application server 113 may be a server or standard PC comprising at least one processor for executing applications or software modules. The application server 113 may comprise at least one processor that is adapted to execute the application of the machines 106 deployed on the worksite 104. Alternatively, or additionally the worksite datacenter 110 may simulate a virtual processor for executing the application. In one embodiment, the application may be executed at least partially within the worksite datacenter 110. It may be possible that some tasks of the application are executed by the application server 113 and other tasks of the computer program are executed in other devices, for example, the controller 108.

The worksite datacenter 110 may also be communicably coupled to an end user device 116 or interface adapted to visualize results of the processing of the sensor data. For example, the end user device 116 may include an output generated and displayed on a display system present on-board the machine 106. Alternatively, the end user device 116 may be deployed at the remote control station from where the machines 106 operating on a given worksite 104 may be manually monitored. In another embodiment, the end user device 116 may provide a combination of display alternatives to be downloaded related to the processed sensor data, such that the display alternatives may provide an optimum cab interface so the operator may increase productivity and flexibility. In yet another embodiment, the sensor data processed by the worksite datacenter 110 associated with different worksites 104 may be shared over the network 112 for reporting purposes.

The controllers 108 and the application servers 113 may embody a single microprocessor or multiple microprocessors known in art. Numerous commercially available microprocessors may be configured to perform the functions of the controllers 108 and the application servers 113. It should be appreciated that the controllers 108 and the database 114 may readily embody a general microprocessor. A person of ordinary skill in the art will appreciate that the worksite datacenter 110 may additionally include other components and may also perform other functionality not described herein. It should be understood that the embodiments and the configurations and connections explained herein are merely on an exemplary basis and may not limit the scope and spirit of the disclosure.

### INDUSTRIAL APPLICABILITY

The present disclosure provides the distributed worksite data management system 100 associated with the machines 106 operating on the worksite 104, such that the distributed worksite data management system 100 facilitates certain services or functionalities to be hosted by the worksite datacenter 110.

The system 100 disclosed herein is distributed and may be easily trialable. Users or operators may use the application to be executed at the respective controllers 108 of the machines 106 in a virtual environment, prior to actual application on the worksite 104. For example, based on projected machine operational data, the controller 108 may be configured to report the estimated machine characteristics prior to employing the same on the machines 106 operating on the worksite 104.

The architecture provided by the worksite datacenter 110 is scalable and flexible such that the hardware and software capabilities offered at the given worksite 104 may not require substantial organic growth. The worksite datacenter 110 may be leveraged and shared across different systems. Further, the disclosed system 100 may be easily replicated and provides a solution offering modularity. The distributed approach is cost effective from a business perspective avoiding the creation of large data warehouses associated with the individual worksites 104 that were otherwise deployed for handling of local processing requirements.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A distributed worksite data management system comprising:
a plurality of machines operating on a worksite;
a data communication device on-board each of the plurality of machines;
a controller on-board each of the plurality of machines, the controller communicably coupled to the data communication device, wherein the controller is configured to:
read sensor data associated with the machine; and
transmit the sensor data to the data communication device of the machine;
a worksite datacenter accessible by the plurality of machines, the worksite datacenter situated remotely from the worksite, the worksite datacenter including:
a plurality of databases; and
a plurality of application servers,
wherein the worksite datacenter is configured to communicate with the data communication device via a network, wherein the network is adapted to transmit data with a network protocol; and
an end user device associated with the plurality of machines, the end user device configured to visualize results of the execution of the application.
